(19) United States
(12) Patent Application Publication
(10) Pub. No.: US 2026/0078253 A1
(43) Pub. Date: Mar. 19, 2026

(54) RESIN COMPOSITION, AND PREPREG, FILM WITH RESIN, METAL FOIL WITH RESIN, METAL-CLAD LAMINATED PLATE, AND WIRING BOARD USING SAME

(71) Applicant: PANASONIC INTELLECTUAL PROPERTY MANAGEMENT CO., LTD., Osaka (JP)

(72) Inventors: Hirosuke SAITO, Osaka (JP); Yasunori NISHIGUCHI, Osaka (JP); Keiko KASHIHARA, Osaka (JP); Takahito HAGIWARA, Osaka (JP)

(73) Assignee: PANASONIC INTELLECTUAL PROPERTY MANAGEMENT CO., LTD., Osaka (JP)

(21) Appl. No.: 19/127,349

(22) PCT Filed: Oct. 10, 2023
(86) PCT No.: PCT/JP2023/036782

§ 371 Date: May 5, 2025

(30) Foreign Application Priority Data
Nov. 11, 2022 (JP) 2022-180984

(51) Int. Cl. C08L 65/00; B32B 5/02; B32B 5/26; B32B 15/20; C08J 5/24; C08K 3/36; C08K 5/01; C08K 5/49; C08L 71/12

(52) U.S. Cl. CPC C08L 65/00; B32B 5/024; B32B 5/263; B32B 15/20; C08J 5/244; C08K 3/36; C08K 5/01; C08K 5/49; C08L 71/126; B32B 2250/04; B32B 2250/40; B32B 2260/021; B32B 2260/046; B32B 2307/204; B32B 2307/206; B32B 2307/7376; B32B 2457/08; C08J 2365/00; C08J 2371/12; C08J 2425/08; C08J 2465/00; C08J 2471/12; C08L 2201/02; C08L 2203/20; C08L 2205/03

(57) ABSTRACT

A resin composition contains a hydrocarbon-based compound (A) represented by the following Formula (1): in Formula (1), X represents a hydrocarbon group having 6 or more carbon atoms, which includes at least one selected from an aromatic cyclic group or an aliphatic cyclic group, and n represents an integer from 1 to 10; a polyphenylene ether compound (B) having a reactive carbon-carbon unsaturated double bond; and at least one of a polyfunctional vinyl aromatic copolymer (C) or an acenaphthylene compound (D).

### TECHNICAL FIELD

The present invention relates to a resin composition and a prepreg, a film with resin, a metal foil with resin, a metal-clad laminate, and a wiring board, which are obtained using the resin composition.

### BACKGROUND ART

In recent years, with the remarkable improvement in information communication speeds in various electronic devices, for example, electronic devices such as switches, routers, and servers, there has been an increasing demand for low transmission loss in printed wiring boards in order to utilize high frequency bands. Polyphenylene ether resin has excellent dielectric properties such as dielectric constant and dielectric loss tangent, and is therefore being investigated as a material for use in high frequency bands.

For example, Patent Literatures 1 and 2 describe that excellent low dielectric properties are attained by a resin composition containing modified polyphenylene ether.

Meanwhile, as chip performance is enhanced, package substrates mounted on printed wiring boards used in electronic devices as mentioned above are also becoming larger, and a substrate having a small coefficient of thermal expansion in the planar direction is adopted in order to suppress warpage of the substrate. As a result, the difference in coefficient of thermal expansion between the package substrate and the printed wiring board becomes large, and a problem arises that the reliability decreases during mounting. Hence, printed wiring boards are required to have not only low dielectric properties but also a low coefficient of thermal expansion.

The present invention is made in view of such circumstances, and an object thereof is to provide a resin composition affording a cured product that can achieve a low coefficient of thermal expansion as well as exhibits low dielectric properties. Another object of the present invention is to provide a prepreg, a film with resin, a metal foil with resin, a metal-clad laminate, and a wiring board, which are obtained using the resin composition.

### CITATION LIST

### Patent Literatures

Patent Literature 1: WO 2014/034103 A
Patent Literature 2: WO 2014/203511 A

### SUMMARY OF INVENTION

A resin composition according to an aspect of the present invention contains a hydrocarbon-based compound (A) represented by the following Formula (1):

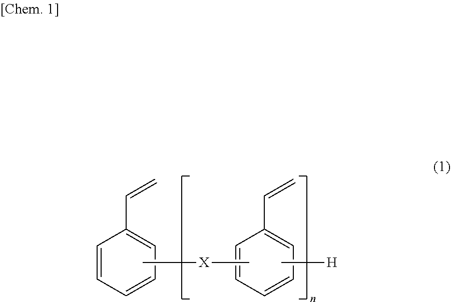

[in Formula (1), X represents a hydrocarbon group having 6 or more carbon atoms, which includes at least one selected from an aromatic cyclic group or an aliphatic cyclic group, and n represents an integer from 1 to 10];
a polyphenylene ether compound (B) having a reactive carbon-carbon unsaturated double bond; and
at least one of a polyfunctional vinyl aromatic copolymer (C) or an acenaphthylene compound (D).

### BRIEF DESCRIPTION OF DRAWINGS

FIG. 1 is a schematic sectional view illustrating the configuration of a prepreg according to an embodiment of the present invention.

FIG. 2 is a schematic sectional view illustrating the configuration of a metal-clad laminate according to an embodiment of the present invention.

FIG. 3 is a schematic sectional view illustrating the configuration of a wiring board according to an embodiment of the present invention.

FIG. 4 is a schematic sectional view illustrating the configuration of a metal foil with resin according to an embodiment of the present invention.

FIG. 5 is a schematic sectional view illustrating the configuration of a film with resin according to an embodiment of the present invention.

FIG. 6 illustrates a GPC chart of the compound obtained in Synthesis Example 1.

FIG. 7 illustrates a ¹H-NMR chart of the compound obtained in Synthesis Example 1.

FIG. 8 illustrates a GPC chart of the compound obtained in Synthesis Example 2.

FIG. 9 illustrates a ¹H-NMR chart of the compound obtained in Synthesis Example 2.

### DESCRIPTION OF EMBODIMENTS

The resin composition according to an embodiment of the present invention (hereinafter, also simply referred to as the resin composition) contains a hydrocarbon-based compound (A) represented by Formula (1), a polyphenylene ether compound (B) having a reactive carbon-carbon unsaturated double bond, and at least one of a polyfunctional vinyl aromatic copolymer (C) or an acenaphthylene compound (D).

By containing at least one of the polyfunctional vinyl aromatic copolymer (C) or the acenaphthylene compound (D) in addition to the hydrocarbon-based compound (A) and the polyphenylene ether compound (B) having a reactive carbon-carbon unsaturated double bond, a cured product of the resin composition can achieve low thermal expansion properties as well as exhibits low dielectric properties. In other words, according to the present invention, it is possible to provide a resin composition affording a cured product that exhibits low thermal expansion properties as well as exhibits low dielectric properties. By using the resin composition, it is possible to provide a prepreg, a film with resin, a metal foil with resin, a metal-clad laminate, and a wiring board, which are excellent in the properties.

In order to maintain high reliability as electronic material properties, adhesive properties and heat resistance are also further required. It is considered that the resin composition of the present embodiment also exhibits excellent adhesive properties and heat resistance in addition to low dielectric properties and low thermal expansion properties by the configuration.

A material imparting a high Tg to the cured product is one of the factors for further improvement in heat resistance (solder heat resistance, reflow heat resistance, and the like). A material imparting a high Tg to a cured product has also an advantage that the coefficient of thermal expansion of the material is a small value in a temperature region from room temperature to reflow or solder temperature. This is because thermal expansion generally increases sharply at a temperature exceeding the glass transition temperature. In other words, when the glass transition temperature is low, the coefficient of thermal expansion increases in a high temperature region exceeding the glass transition temperature. In wiring boards, when the glass transition temperature is low, the coefficient of thermal expansion in the vertical direction increases in a high temperature region, and for example, troubles such as disconnecting through holes and laser via holes may occur and connection reliability may decrease. According to the configuration of the present embodiment as described above, it is considered that a resin composition affording a cured product also having a high Tg can be provided.

Hereinafter, the respective components of the resin composition according to the present embodiment will be specifically described.

### <Hydrocarbon-Based Compound (A)>

The hydrocarbon-based compound (A) contained in the resin composition of the present embodiment is a compound represented by the following Formula (1).

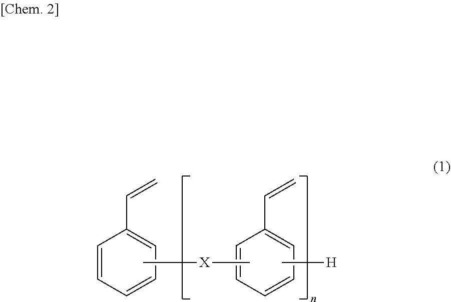

In Formula (1), X represents a hydrocarbon group having 6 or more carbon atoms, which includes at least one selected from an aromatic cyclic group or an aliphatic cyclic group. n represents an integer from 1 to 10.

By containing such a hydrocarbon-based compound (A), it is considered that the resin composition of the present embodiment affords a cured product that can attain low dielectric properties and further have a low coefficient of thermal expansion.

The aromatic cyclic group is not particularly limited, but examples thereof include a phenylene group, a xylylene group, a naphthylene group, a tolylene group, and a biphenylene group.

The aliphatic cyclic group is not particularly limited, but examples thereof include a group containing an indane structure represented by the following Formula (3) and a group containing a cycloolefin structure.

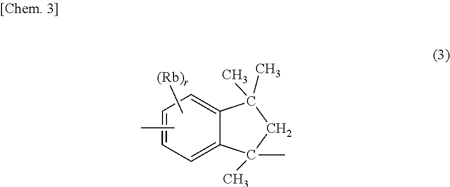

In Formula (3), Rb's are independent of each other. In other words, Rb's may be the same group as or different groups from each other, and for example, when r is 2 or 3, two or three Rb's bonded to the same benzene ring may be the same group as or different groups from each other. Rb represents an alkyl group having 1 to 10 carbon atoms, an alkyloxy group (alkoxy group) having 1 to 10 carbon atoms, an alkylthio group having 1 to 10 carbon atoms, an aryl group having 6 to 10 carbon atoms, an aryloxy group having 6 to 10 carbon atoms, an arylthio group having 6 to 10 carbon atoms, a cycloalkyl group having 3 to 10 carbon atoms, a halogen atom, a hydroxyl group, or a mercapto group (thiol group). r represents an integer from 0 to 3.

The number of carbon atoms in Formula (1) is not particularly limited as long as it is 6 or more, but is more preferably 6 or more and 20 or less from the viewpoint of maintaining a high Tg.

In a preferred embodiment, the hydrocarbon-based compound of the present embodiment includes a hydrocarbon-based compound (A1) represented by the following Formula (2).

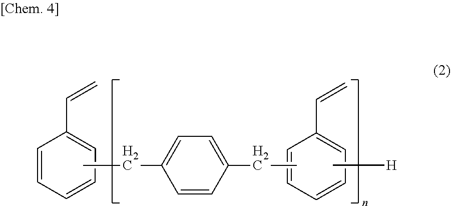

In Formula (2), n represents an integer from 1 to 10.

By containing such a hydrocarbon-based compound (A1), it is considered that the effects as described above can be attained more reliably.

### <Polyphenylene Ether Compound (B)>

As the polyphenylene ether compound (B), a polyphenylene ether compound having a reactive carbon-carbon unsaturated double bond is used. For example, since it is preferable to use a terminal-modified polyphenylene ether compound that can exert excellent low dielectric properties when cured, and it is preferable to use a modified polyphenylene ether compound of which the terminal is modified with a substituent having a carbon-carbon unsaturated double bond as the polyphenylene ether compound (B).

Examples of the substituent having a carbon-carbon unsaturated double bond include a group having a styrene structure or a (meth)acrylate structure as represented by the following Formula (4) or (5).

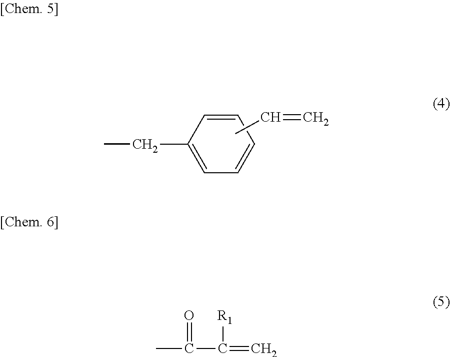

In Formula (5), R₁ represents a hydrogen atom or an alkyl group. The alkyl group is not particularly limited and is, for example, preferably an alkyl group having 1 to 18 carbon atoms, more preferably an alkyl group having 1 to 10 carbon atoms. Specific examples thereof include a methyl group, an ethyl group, a propyl group, a hexyl group, and a decyl group.

More specifically, examples of the substituent include: vinylbenzyl group (ethenylbenzyl group) such as p-ethenylbenzyl group and m-ethenylbenzyl group, vinylphenyl group, acrylate group, and methacrylate group.

It is considered that by using the modified polyphenylene ether compound like this, low dielectric properties such as low dielectric constant and low dielectric loss tangent and excellent heat resistance can be maintained and also higher Tg and adhesive properties can be enhanced.

One kind of the modified polyphenylene ether compounds can be used singly, or two or more kinds thereof can be used in combination.

In the present embodiment, the weight average molecular weight (Mw) of the modified polyphenylene ether compound used as a thermosetting resin is not particularly limited, but is, for example, preferably 1000 to 5000, more preferably 1000 to 4000. Here, the weight average molecular weight may be measured by a general molecular weight measurement method, and specific examples thereof include a value measured by gel permeation chromatography (GPC). In a case where the modified polyphenylene ether compound has repeating units (s, m, and n) in the molecule, these repeating units are preferably numerical values such that the weight average molecular weight of the modified polyphenylene ether compound falls within this range.

When the weight average molecular weight of the modified polyphenylene ether compound is within such a range, the excellent low dielectric properties of the polyphenylene ether skeleton are exhibited and a cured product exhibiting not only superior heat resistance but also excellent moldability is afforded. This is considered to be due to the following. In comparison with a typical polyphenylene ether, the modified polyphenylene ether compound having a weight average molecular weight within a range set forth above has a relatively low molecular weight, and hence the heat resistance of the cured product tends to decrease. With this regard, the modified polyphenylene ether compound according to the present embodiment has a styrene structure or a (meth)acrylate structure at the terminal and hence has a high reactivity, and it is considered to afford a cured product whose heat resistance is sufficiently high. When the weight average molecular weight of the modified polyphenylene ether compound is within the range like this, the modified polyphenylene ether compound has a higher molecular weight than that of styrene or divinylbenzene but has a relatively lower molecular weight than that of typical polyphenylene ether, and hence it is considered that the modified polyphenylene ether compound is excellent in moldability as well. Therefore, the modified polyphenylene ether compound like this is considered to afford a cured product excellent not only in heat resistance but also excellent in moldability.

In the modified polyphenylene ether compound used as the thermosetting resin in the present exemplary embodiment, the average number of the substituents (the number of terminal functional groups) included at the molecular terminal per molecule of the modified polyphenylene ether is not particularly limited. Specifically, the number of terminal functional groups is preferably 1 to 5, more preferably 1 to 3. When the number of terminal functional groups is too small, it tends to be difficult to obtain a cured product exhibiting sufficient heat resistance. When the number of terminal functional groups is too large, the reactivity is too high, and for example, there is a possibility that troubles such as a deterioration in storage stability of the resin composition and a decrease in fluidity of the resin composition may occur. In other words, there is a possibility that the use of such a modified polyphenylene ether causes moldability problems in that, for example, molding defects such as voids are generated during multilayer molding by poor fluidity and the like and it is difficult to obtain a highly reliable printed wiring board.

The number of terminal functional groups in the modified polyphenylene ether compound includes a numerical value representing the average value of the substituents per molecule of all modified polyphenylene ether compounds present in 1 mole of the modified polyphenylene ether compound. This number of terminal functional groups can be determined by, for example, calculating the decrease from the number of hydroxyl groups in the polyphenylene ether before modification to the number of hydroxyl groups remaining in the resulting modified polyphenylene ether compound. The number of hydroxyl groups decreased from the number of hydroxyl groups in the polyphenylene ether before being modified is the number of terminal functional groups. With regard to the method for measuring the number of hydroxyl groups remaining in the modified polyphenylene ether compound, the number of hydroxyl groups can be determined by adding a quaternary ammonium salt (tetraethylammonium hydroxide) to be associated with a hydroxyl group to a solution of the modified polyphenylene ether compound and measuring the UV absorbance of the mixed solution.

The intrinsic viscosity of the modified polyphenylene ether compound used in the present embodiment is not particularly limited. Specifically, the intrinsic viscosity may be 0.03 to 0.12 dl/g, but is preferably 0.04 to 0.11 dl/g, more preferably 0.06 to 0.095 dl/g. When the intrinsic viscosity is too low, the molecular weight tends to be low and low dielectric properties such as a low dielectric constant and a low dielectric loss tangent tend to be hardly attained. In contrast, when the intrinsic viscosity is too high, the viscosity increases, sufficient fluidity is not exhibited, and the moldability of the cured product tends to be deteriorated. Hence, when the intrinsic viscosity of the modified polyphenylene ether compound is within the range set forth above, excellent heat resistance and moldability of the cured product can be realized.

The intrinsic viscosity here is an intrinsic viscosity measured in methylene chloride at 25° C. and more specifically is, for example, a value attained by measuring the intrinsic viscosity of a methylene chloride solution (liquid temperature: 25° C.) at 0.18 g/45 ml using a viscometer. Examples of the viscometer include AVS500 Visco System manufactured by SCHOTT Instruments GmbH.

The polyphenylene ether compound used in the resin composition of the present embodiment can be synthesized by a known method, or a commercially available polyphenylene ether compound can also be used. Examples of the commercially available product include: “OPE-2st 1200” and “OPE-2st 2200” manufactured by Mitsubishi Gas Chemical Company Inc., and “SA 9000” manufactured by SABIC Innovative Plastics.

### <Polyfunctional Vinyl Aromatic Polymer (C)>

The resin composition of the present embodiment contains, in addition to the components (A) and (B), at least one selected from a polyfunctional vinyl aromatic polymer (C) or an acenaphthylene compound (D) described later. By containing at least one selected from the polyfunctional vinyl aromatic polymer (C) or the acenaphthylene compound (D), the resin composition of the present embodiment can more reliably attain the effects of low dielectric properties and low thermal expansion properties as described above.

In particular, by containing the polyfunctional vinyl aromatic polymer (C), the resin composition exhibits superior dielectric properties. By containing the acenaphthylene compound (D) described later, there is an advantage that the resin composition exhibits superior low thermal expansion properties, heat resistance, and high glass transition temperature. Furthermore, it is considered that the resin composition also exhibits superior adhesive properties.

The resin composition of the present embodiment may contain both the polyfunctional vinyl aromatic polymer (C) and the acenaphthylene compound (D), and in that case, a cured product having the effects (low dielectric properties, low thermal expansion properties, high Tg and heat resistance) as described above in a well-balanced manner can be obtained.

The polyfunctional vinyl aromatic copolymer (B) contains a repeating unit (a) derived from a divinyl aromatic compound and a repeating unit (b) derived from a monovinyl aromatic compound and further contains a repeating unit (a1) represented by the following Formula (a1) as a part of the repeating unit (a) derived from a divinyl aromatic compound.

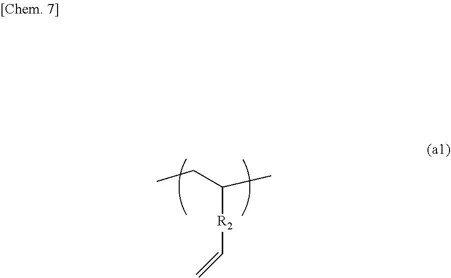

In Formula (a1), R₂ represents an aromatic hydrocarbon group having 6 to 30 carbon atoms.

In the polyfunctional vinyl aromatic copolymer (B), it is preferable that the repeating unit (a) is contained at 2 mol % or more and less than 95 mol % and the repeating unit (b) is contained at 5 mol % or more and less than 98 mol % when the total of the repeating unit (a) and the repeating unit (b) is set to 100 mol %. The repeating unit (a1) is preferably contained at 2 to 80 mol % when the total of the repeating units (a) and (b) is set to 100 mol %.

It is preferable that the number average molecular weight Mn of the polyfunctional vinyl aromatic copolymer (B) is 300 to 100,000 and the molecular weight distribution, which is expressed as the ratio of the weight average molecular weight Mw to the number average molecular weight, is 100.0 or less. The polyfunctional vinyl aromatic copolymer (A-1) is preferably soluble in toluene, xylene, tetrahydrofuran, dichloroethane or chloroform.

The polyfunctional vinyl aromatic copolymer (B) is not particularly limited, but examples thereof include a copolymer, which is represented by the following Formula (6) and contains structural units derived from the repeating unit (a) derived from a divinyl aromatic compound and the repeating unit (b) derived from a monovinyl aromatic compound. These structural units may be arranged regularly or randomly.

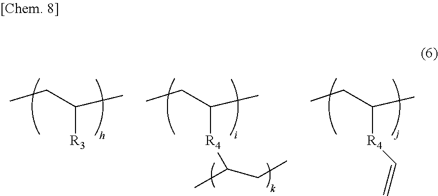

In Formula (6), R₃ is an aromatic hydrocarbon group having 6 to 30 carbon atoms, which is derived from a monovinyl aromatic compound, R₄ is an aromatic hydrocarbon group having 6 to 30 carbon atoms, which is derived from a divinyl aromatic compound, and h to k are each independently an integer from 0 to 200, provided that the total thereof is 2 to 20,000.

Preferably, the polyfunctional vinyl aromatic copolymer (B) is a copolymer composed of repeating units in which R₃ and R₄ in Formula (6) are aromatic hydrocarbon groups selected from the group consisting of a phenyl group optionally having a substituent, a biphenyl group optionally having a substituent, a naphthalene group optionally having a substituent, and a terphenyl group optionally having a substituent.

The polyfunctional vinyl aromatic copolymer (B) is preferably soluble in a solvent. The repeating unit as used herein is derived from a monomer, and includes units that are present in the main chain of the copolymer and appear repeatedly and units or terminal groups that are present in the terminals or side chains. A repeating unit is also called a structural unit.

The structural unit (a) derived from a divinyl aromatic compound is preferably contained at 2 mol % or more and less than 95 mol % with respect to the total sum of a divinyl aromatic compound and the structural unit (b) derived from a monovinyl aromatic compound. The structural unit (a) derived from a divinyl aromatic compound can have a plurality of structures, such as one in which only one of two vinyl groups has reacted and one in which two of two vinyl groups have reacted, but among these, the repeating unit, in which only one vinyl group is reacted, represented by Formula (a1) is contained at preferably 2 to 80 mol %, more preferably 5 to 70 mol %, still more preferably 10% to 60%, particularly preferably 15% to 50% with respect to the total sum. It is considered that by setting the repeating unit content to 2 to 80 mol %, the dielectric loss tangent is low, heat resistance is excellent, and compatibility with other resins is excellent. The heat resistance tends to decrease when the repeating unit content is less than 2 mol %, and the adhesive strength tends to decrease when the repeating unit content exceeds 80 mol %.

The polyfunctional vinyl aromatic copolymer (B) preferably contains the structural unit (b) derived from a monovinyl aromatic compound at 5 mol % or more and less than 98 mol % with respect to the total sum. The structural unit (a2) is contained at more preferably 10 mol % or more and less than 90 mol %. The content of the structural unit (a2) is still more preferably 15 mol % or more and less than 85 mol %. The molding processability may be insufficient when the content of the structural unit (a2) is less than 5 mol %, and the heat resistance of the cured product may be insufficient when the content of the structural unit (a2) exceeds 98 mol %.

The vinyl group present in Formula (a1) acts as a crosslinking component and contributes to exertion of heat resistance of the polyfunctional vinyl aromatic copolymer (B). Meanwhile, the structural unit (b) derived from a monovinyl aromatic compound does not have a vinyl group since it is considered that the polymerization usually proceeds through the 1,2-addition reaction of a vinyl group. In other words, the structural unit (b) derived from a monovinyl aromatic compound does not act as a crosslinking component but contributes to exertion of moldability.

Examples of the monovinyl aromatic compound preferably include styrene. A monovinyl aromatic compound other than styrene can be used together with styrene. In this case, the content of the structural unit (b1) derived from styrene is preferably 99 to 20 mol % when the total content of the structural unit (b1) derived from styrene and the structural unit (b2) derived from a monovinyl aromatic compound other than styrene is set to 100 mol %. The content of the structural unit (a2-1) is more preferably 98 to 30 mol %. It is preferable that the content of (b1) is in the above range since both resistance to thermal oxidation deterioration and moldability are exhibited. The heat resistance tends to decrease in a case where the structural unit (b1) is more than 99 mol %, and the moldability tends to decrease in a case where the structural unit (b2) is more than 80 mol %.

The number average molecular weight (number average molecular weight in terms of standard polystyrene measured using GPC) of the polyfunctional vinyl aromatic copolymer (B) is preferably 300 to 100,000, more preferably 400 to 50,000, still more preferably 500 to 10,000. When the Mn is less than 300, the amount of the monofunctional copolymer component contained in the polyfunctional vinyl aromatic copolymer (B) increases, and the heat resistance of the cured product tends to decrease. When the Mn exceeds 100,000, gel is easily generated, the viscosity increases, and the molding processability tends to decrease. The value of the molecular weight distribution (Mw/Mn) expressed as the ratio of the weight average molecular weight (weight average molecular weight in terms of standard polystyrene measured using GPC) to Mn is 100.0 or less, preferably 50.0 or less, more preferably 1.5 to 30.0, most preferably 2.0 to 20.0. When the Mw/Mn exceeds 100.0, the processing characteristics of the polyfunctional vinyl aromatic copolymer (B) tend to be poor, and gel tends to be generated.

The divinyl aromatic compound plays a role in forming a branched structure and making the copolymer polyfunctional as well as plays a role as a crosslinking component for exerting heat resistance when the obtained polyfunctional vinyl aromatic copolymer (B) is heat-cured. Examples of the divinyl aromatic compound are not particularly limited as long as they are aromatic compounds having two vinyl groups, but divinylbenzene (including the respective regioisomers or mixtures thereof), divinylnaphthalene (including the respective regioisomers or mixtures thereof), and divinylbiphenyl (including the respective regioisomers or mixtures thereof) are preferably used. These can be used singly or in combination of two or more kinds thereof. Divinylbenzene (m-isomer, p-isomer, or a regioisomer mixture thereof) is more preferable from the viewpoint of molding processability.

Examples of the monovinyl aromatic compound include styrene and monovinyl aromatic compounds other than styrene. However, it is desirable to use styrene essentially and a monovinyl aromatic compound other than styrene concurrently.

Styrene plays a role in imparting low dielectric properties and resistance to thermal oxidation deterioration to the polyfunctional vinyl aromatic copolymer (B) as a monomer component as well as plays a role in controlling the molecular weight of the polyfunctional vinyl aromatic copolymer (B) as a chain transfer agent. The monovinyl aromatic compound other than styrene improves the solubility in solvent and processability of the polyfunctional vinyl aromatic copolymer (B).

Examples of the monovinyl aromatic compound other than styrene are not particularly limited as long as they are aromatic compounds having one vinyl group other than styrene, and include vinyl aromatic compounds such as vinylnaphthalene and vinylbiphenyl; and nuclear alkyl-substituted vinyl aromatic compounds such as o-methylstyrene, m-methylstyrene, p-methylstyrene, o,p-dimethylstyrene, o-ethylvinylbenzene, m-ethylvinylbenzene and p-ethylvinylbenzene. The monovinyl aromatic compound other than styrene is preferably ethylvinylbenzene (including the respective regioisomers or mixtures thereof), ethylvinylbiphenyl (including the respective regioisomers or mixtures thereof), or ethylvinylnaphthalene (including the respective regioisomers and mixtures thereof) since the compound prevents gelation of the polyfunctional vinyl aromatic copolymer (B), is highly effective in improving solubility in solvent and processability, is low in cost, and is readily available. From the viewpoints of dielectric properties and cost, ethylvinylbenzene (m-isomer, p-isomer or a regioisomer mixture thereof) is more preferable.

In addition to the divinyl aromatic compound and the monovinyl aromatic compound, structural units (c) derived from one or two or more other monomer components such as a trivinyl aromatic compound, a trivinyl aliphatic compound, a divinyl aliphatic compound, and a monovinyl aliphatic compound can be introduced into the polyfunctional vinyl aromatic copolymer (B) as long as the effects of the present invention are not impaired.

Examples of the other monomer components include 1,3,5-trivinylbenzene, 1,3,5-trivinylnaphthalene, 1,2,4-trivinylcyclohexane, ethylene glycol diacrylate, butadiene, 1,4-butanediol divinyl ether, cyclohexanedimethanol divinyl ether, diethylene glycol divinyl ether and triallyl isocyanurate. These can be used singly or in combination of two or more kinds thereof.

The mole fraction of the other monomer components is preferably less than 30 mol % with respect to the total sum of all monomer components. In other words, the mole fraction of the repeating unit (c) derived from other monomer components is preferably less than 30 mol % with respect to the total sum of the structural units (a), (b), and (c)) derived from all the monomer components constituting the copolymer.

### <Acenaphthylene Compound (D)>

As the acenaphthylene compound (D), any acenaphthylene compound can be used without particular limitation as long as it is a compound having an acenaphthylene structure in the molecule. Examples of the acenaphthylene compound (D) include acenaphthylene, alkylacenaphthylenes, halogenated acenaphthylenes, and phenylacenaphthylenes.

Examples of the alkyl acenaphthylenes include 1-methyl acenaphthylene, 3-methyl acenaphthylene, 4-methyl acenaphthylene, 5-methyl acenaphthylene, 1-ethyl acenaphthylene, 3-ethyl acenaphthylene, 4-ethyl acenaphthylene, and 5-ethyl acenaphthylene. Examples of the halogenated acenaphthylenes include 1-chloroacenaphthylene, 3-chloroacenaphthylene, 4-chloroacenaphthylene, 5-chloroacenaphthylene, 1-bromoacenaphthylene, 3-bromoacenaphthylene, 4-bromoacenaphthylene, and 5-bromoacenaphthylene. Examples of the phenylacenaphthylenes include 1-phenylacenaphthylene, 3-phenylacenaphthylene, 4-phenylacenaphthylene, and 5-phenylacenaphthylene. The acenaphthylene compound may be a monofunctional acenaphthylene compound having one acenaphthylene structure in the molecule as described above or may be a polyfunctional acenaphthylene compound having two or more acenaphthylene structures in the molecule.

### (Content)

In the resin composition of the present embodiment, the content of the hydrocarbon-based compound (A) is preferably 5 to 50 parts by mass with respect to 100 parts by mass of the total mass of the hydrocarbon-based compound (A), the polyphenylene ether compound (B), the polyfunctional vinyl aromatic copolymer (C), and the acenaphthylene compound (D). When the content is in such a range, it is considered that the effects of the present invention as described above can be attained more reliably. A more preferable range of the content is 15 parts by mass or more and 50 parts by mass or less.

The content of the polyphenylene ether compound (B) in the resin composition of the present embodiment is preferably 5 to 50 parts by mass with respect to 100 parts by mass of the total mass of the hydrocarbon-based compound (A), the polyphenylene ether compound (B), the polyfunctional vinyl aromatic copolymer (C), and the acenaphthylene compound (D). When the content is in such a range, it is considered that the effects of the present invention as described above can be attained more reliably. A more preferable range of the content is 15 parts by mass or more and 35 parts by mass or less.

The content of the polyfunctional vinyl aromatic copolymer (C) in the resin composition of the present embodiment is preferably 0 to 50 parts by mass with respect to 100 parts by mass of the total mass of the hydrocarbon-based compound (A), the polyphenylene ether compound (B), the polyfunctional vinyl aromatic copolymer (C), and the acenaphthylene compound (D). When the content is in such a range, it is considered that the effects of the present invention as described above can be attained more reliably. A more preferable range of the content is 10 parts by mass or more and 40 parts by mass or less.

The content of the acenaphthylene compound (D) in the resin composition of the present embodiment is preferably 0 to 30 parts by mass with respect to 100 parts by mass of the total mass of the hydrocarbon-based compound (A), the polyphenylene ether compound (B), the polyfunctional vinyl aromatic copolymer (C), and the acenaphthylene compound (D). When the content is in such a range, it is considered that the effects of the present invention as described above can be attained more reliably. A more preferable range of the content is 10 parts by mass or more and 25 parts by mass or less.

### (Inorganic Filler)

The resin composition according to the present embodiment may further contain an inorganic filler. The inorganic filler is not particularly limited and includes those added to enhance the heat resistance and flame retardancy of the cured product of a resin composition. By containing an inorganic filler, it is considered that heat resistance, flame retardancy and the like can be further enhanced as well as the coefficient of thermal expansion can be kept lower (achievement of even lower thermal expansion properties).

Specific examples of the inorganic filler that can be used in the present embodiment include metal oxides such as silica, alumina, titanium oxide, magnesium oxide, and mica, metal hydroxides such as magnesium hydroxide and aluminum hydroxide, talc, aluminum borate, barium sulfate, aluminum nitride, boron nitride, barium titanate, strontium titanate, calcium titanate, aluminum titanate, barium zirconate titanate, barium zirconate, calcium zirconate, zirconium phosphate, zirconium tungstate phosphate, magnesium carbonate such as anhydrous magnesium carbonate, calcium carbonate, and boehmite-treated products thereof. Among these, silica, metal hydroxides such as magnesium hydroxide and aluminum hydroxide, aluminum oxide, boron nitride, and barium titanate, strontium titanate and the like are preferable, and silica is more preferable. The silica is not particularly limited, and examples thereof include crushed silica, spherical silica, and silica particles.

These inorganic fillers may be used singly or in combination of two or more kinds thereof. An inorganic filler as described above may be used as it is, but one subjected to a surface treatment with an epoxysilane-type, vinylsilane-type, methacrylsilane-type, phenylaminosilane-type, or aminosilane-type silane coupling agent may be used. The silane coupling agent can be used by being added to the filler by an integral blend method instead of the method of treating the surface of the filler with the silane coupling agent in advance.

In a case where the resin composition of the present embodiment contains an inorganic filler, the content thereof is preferably 10 to 300 parts by mass, more preferably 40 to 250 parts by mass with respect to 100 parts by mass of the total mass of the hydrocarbon-based compound (A), the polyphenylene ether compound (B), the polyfunctional vinyl aromatic copolymer (C), and the acenaphthylene compound (D).

### (Flame Retardant)

The resin composition according to the present embodiment may further contain a flame retardant. The flame retardancy of a cured product of the resin composition can be further enhanced by containing a flame retardant.

The flame retardant that can be used in the present embodiment is not particularly limited. Specifically, in the field in which halogen-based flame retardants such as bromine-based flame retardants are used, for example, ethylenedipentabromobenzene, ethylenehistetrabromoimide, decabromodiphenyloxide, and tetradecabromodiphenoxybenzene which have a melting point of 300° C. or more are preferable. It is considered that the elimination of halogen at a high temperature and the decrease in heat resistance can be suppressed by the use of a halogen-based flame retardant. There is a case where a flame retardant containing phosphorus (phosphorus-based flame retardant) is used in fields required to be halogen-free. The phosphorus-based flame retardant is not particularly limited, and examples thereof include an HCA-based flame retardant, a phosphate ester-based flame retardant, a phosphazene-based flame retardant, a bis(diphenylphosphine oxide)-based flame retardant, and a phosphinate-based flame retardant. Specific examples of the HCA-based flame retardant include 9,10-dihydro-9-oxa-10-phosphaphenanthren-10-yl-10-oxide, 10-(2,5-dihydroxyphenyl)-9,10-dihydro-9-oxa-10-phosphaphenanthrene-10-oxide, and compounds obtained by reacting these in advance. Specific examples of the phosphate ester-based flame retardant include a condensed phosphate ester such as dixylenyl phosphate. Specific examples of the phosphazene-based flame retardant include phenoxyphosphazene. Specific examples of the bis(diphenylphosphine oxide)-based flame retardant include xylylenebis(diphenylphosphine oxide). Specific examples of the phosphinate-based flame retardant include metal phosphinates such as an aluminum dialkyl phosphinate. As the flame retardant, the respective flame retardants exemplified may be used singly or in combination of two or more kinds thereof.

In a case where the resin composition of the present embodiment contains a flame retardant, the content of the flame retardant is preferably 5 to 50 parts by mass, more preferably 10 to 40 parts by mass with respect to 100 parts by mass of the total mass of the resin composition except for the inorganic filler.

### Other Components

The resin composition according to the present embodiment may contain components (other components) in addition to the components described above if necessary as long as the effects of the present invention are not impaired. As the other components contained in the resin composition according to the present embodiment, for example, additives such as radical polymerizable compounds, styrenic elastomers, catalysts such as reaction initiators and reaction accelerators, silane coupling agents, polymerization inhibitors, polymerization retarders, flame retardant auxiliaries, defoamers, leveling agents, antioxidants, heat stabilizers, antistatic agents, ultraviolet absorbers, dyes and pigments, dispersants, and lubricants.

### (Radical Polymerizable Compound)

The radical polymerizable compound that can be used in the present embodiment is not particularly limited as long as it is a radical polymerizable compound that reacts with at least one of the components (A) to (D). Examples thereof include a vinyl compound, an allyl compound, an acrylate compound, a methacrylate compound, and a maleimide compound.

The vinyl compound that can be used in the present embodiment is a compound having a vinyl group in the molecule, and examples thereof include a polyfunctional vinyl compound having two or more vinyl groups in the molecule. Examples of the polyfunctional vinyl compound include divinylbenzene, curable polybutadiene having a carbon-carbon unsaturated double bond in the molecule, and a curable butadiene-styrene copolymer having a carbon-carbon unsaturated double bond in the molecule.

The allyl compound that can be used in the present embodiment is a polyfunctional allyl compound having two or more allyl groups in the molecule, and examples thereof include a triallyl isocyanurate compound such as triallyl isocyanurate (TAIC), a diallyl bisphenol compound, and diallyl phthalate (DAP).

The acrylate compound that can be used in the present embodiment is a compound having an acryloyl group in the molecule, and examples thereof include a polyfunctional acrylate compound having two or more acryloyl groups in the molecule. Examples of the polyfunctional acrylate compound include diacrylate compounds such as tricyclodecanedimethanol diacrylate.

The methacrylate compound that can be used in the present embodiment is a compound having a methacryloyl group in the molecule, and examples thereof include a polyfunctional methacrylate compound having two or more methacryloyl groups in the molecule. Examples of the polyfunctional methacrylate compound include dimethacrylate compounds such as tricyclodecanedimethanol dimethacrylate (DCP).

As the maleimide compound usable in the present embodiment, any compound having a maleimide group in the molecule can be used without particular limitation. Specifically, examples of the maleimide compound include: monofunctional maleimide compounds having one maleimide group in the molecule, polyfunctional maleimide compounds having two or more maleimide groups in the molecule, and modified maleimide compounds. Examples of the polyfunctional maleimide compound include aromatic maleimide compounds containing an aromatic group in the molecule, imide group-containing maleimide compounds having an imide group in the molecule, aliphatic maleimide compounds containing a long-chain alkyl group in the molecule, maleimide compounds containing an indane structure in the molecule, maleimide compounds having an arylene structure, which is bonded by being oriented at the meta position, in the molecule. Examples of the modified maleimide compound include a modified maleimide compound in which a part of the molecule is modified with an amine compound, a modified maleimide compound in which a part of the molecule is modified with a silicone compound, and a modified maleimide compound in which a part of the molecule is modified with an amine compound and a silicone compound.

### (Styrenic Elastomer)

The styrenic elastomer that can be used in the present embodiment is a polymer obtained by polymerizing a monomer including a styrenic monomer, and may be a styrenic copolymer. Examples of the styrenic copolymer include: copolymers obtained by copolymerizing one or more styrenic monomers and one or more of other monomers copolymerizable with the styrenic monomers. The styrenic copolymer may be a random copolymer or a block copolymer as long as a structure derived from the styrenic monomer is included in the molecule. Examples of the block copolymer include a bipolymer of the structure (repeating unit) derived from the styrenic monomer and the other copolymerizable monomer (repeating unit) and a terpolymer of the structure (repeating unit) derived from the styrenic monomer, the other copolymerizable monomer (repeating unit), and the structure (repeating unit) derived from the styrenic monomer.

The styrenic elastomer may be a hydrogenated styrenic copolymer obtained by hydrogenating the styrenic copolymer.

As the styrenic elastomer, one styrenic polymer may be used singly, or two or more kinds thereof may be used in combination.

As the styrenic elastomer, commercially available products can be used, and for example, “SEPTON (registered trademark) V9827”, “SEPTON (registered trademark) 2063” and the like manufactured by Kuraray Co., Ltd.; “FTR (registered trademark) 2140”, “FTR (registered trademark) 6125” and the like manufactured by Mitsui Chemicals, Inc.; “Tuftec (registered trademark) H1517” and the like manufactured by Asahi Kasei Corporation; and “DYNARON (registered trademark) 9901P” and the like manufactured by JSR Corporation may be used.

The resin composition according to the present embodiment may contain a reaction initiator (catalyst) and a reaction accelerator as described above. The reaction initiator and reaction accelerator are not particularly limited as long as they can promote the curing reaction of the resin composition. Specifically, examples thereof include metal oxides, azo compounds, peroxides, imidazole compounds, phosphorus-based curing accelerators, and amine-based curing accelerators.

(Prepreg, Film with Resin, Metal-Clad Laminate, Wiring Board, and Metal Foil with Resin)

Next, a prepreg for wiring board, a metal-clad laminate, a wiring board, and a metal foil with resin obtained using the resin composition of the present embodiment will be described.

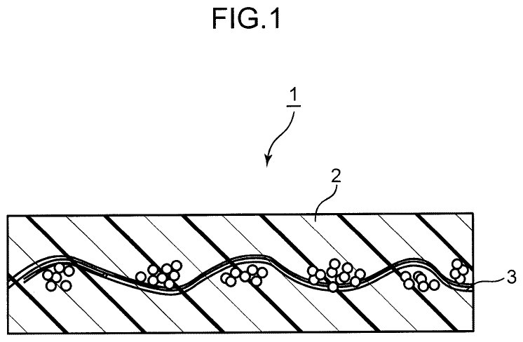

FIG. 1 is a schematic sectional view illustrating an example of a prepreg 1 according to an embodiment of the present invention. The respective symbols in the drawings indicate the following: 1 prepreg, 2 resin composition or semi-cured product of resin composition, 3 fibrous base material, 11 metal-clad laminate, 12 insulating layer, 13 metal foil, 14 wiring, 21 wiring board, 31 metal foil with resin, 32, 42 resin layer, 41 film with resin, and 43 support film.

As illustrated in FIG. 1, the prepreg 1 according to the present embodiment includes the resin composition or a semi-cured product 2 of the resin composition and a fibrous base material 3. Examples of the prepreg 1 include those in which the fibrous base material 3 is present in the resin composition or a semi-cured product 2 thereof. In other words, the prepreg 1 includes the resin composition or semi-cured product thereof; and the fibrous base material 3 present in the resin composition or semi-cured product 2 thereof.

In the present embodiment, the “semi-cured product” is one in a state in which the resin composition is partially cured so as to be further cured. In other words, the semi-cured product is the resin composition in a semi-cured state (B-staged). For example, when a resin composition is heated, the viscosity of the resin composition first gradually decreases, then curing starts, and the viscosity gradually increases. In such a case, semi-curing includes the state between after the viscosity starts to increase and before the resin composition is completely cured.

The prepreg obtained using the resin composition according to the present embodiment may include a semi-cured product of the resin composition as described above, or may include the uncured resin composition itself. In other words, the prepreg may be a prepreg including a semi-cured product of the resin composition (the resin composition in B stage) and a fibrous base material, or may be a prepreg including the resin composition before curing (the resin composition in A stage) and a fibrous base material. Specific examples of the prepreg include those in which a fibrous base material is present in the resin composition. The resin composition or semi-cured product thereof may be one obtained by heating and drying the resin composition.

When the prepreg and the metal foil with resin, metal-clad laminate and the like to be described later are fabricated, the resin composition according to the present embodiment is often prepared in the form of a varnish and used as a resin varnish. Such a resin varnish is prepared, for example, as follows.

First, the respective components that can be dissolved in an organic solvent, such as a resin component and a reaction initiator, are put into an organic solvent and dissolved. At this time, heating may be performed, if necessary. Thereafter, an inorganic filler and the like, which are components that do not dissolve in an organic solvent, are added to and dispersed in the solution until a predetermined dispersion state is achieved using a ball mill, a bead mill, a planetary mixer, a roll mill or the like, whereby a varnish-like resin composition is prepared. The organic solvent used here is not particularly limited as long as it dissolves the hydrocarbon-based compound (A), the polyphenylene ether compound (B), the polyfunctional vinyl aromatic copolymer (C), the acenaphthylene compound (D) and the like and does not inhibit the curing reaction. Specific examples thereof include toluene, methyl ethyl ketone, cyclohexanone, cyclopentanone, methylcyclohexane, dimethylformamide, and propylene glycol monomethyl ether acetate. These may be used singly or two or more kinds thereof may be used concurrently.

Examples of the method for fabricating the prepreg 1 of the present embodiment using the varnish-like resin composition of the present embodiment include a method in which the fibrous base material 3 is impregnated with the resin composition 2 in the form of a resin varnish and then drying is performed.

Specific examples of the fibrous base material used in fabrication of the prepreg include glass cloth, aramid cloth, polyester cloth, LCP (liquid crystal polymer) nonwoven fabric, glass nonwoven fabric, aramid nonwoven fabric, polyester nonwoven fabric, pulp paper, and linter paper. When glass cloth is used, a laminate exhibiting excellent mechanical strength is obtained, and glass cloth subjected to flattening is particularly preferable. The glass cloth used in the present embodiment is not particularly limited, but examples thereof include glass cloth such as E glass, S glass, NE glass, Q glass, and L glass. Specifically, the flattening can be carried out, for example, by continuously pressing the glass cloth with press rolls at an appropriate pressure to flatten the yarn. As for the thickness of the fibrous base material, for example, a fibrous base material having a thickness of 0.01 to 0.3 mm can be generally used.

Impregnation of the fibrous base material 3 with the resin varnish (resin composition 2) is performed by dipping, coating, or the like. This impregnation can be repeated multiple times if necessary. At this time, it is also possible to repeat impregnation using a plurality of resin varnishes having different compositions and concentrations, and adjust the composition (content ratio) and resin amount to the finally desired values.

The fibrous base material 3 impregnated with the resin varnish (resin composition 2) is heated under desired heating conditions, for example, at 80° C. or more and 180° C. or less for 1 minute or more and 10 minutes or less. By heating, the solvent is volatilized from the varnish and the solvent is diminished or removed to obtain the prepreg 1 before curing (in A stage) or in a semi-cured state (B stage).

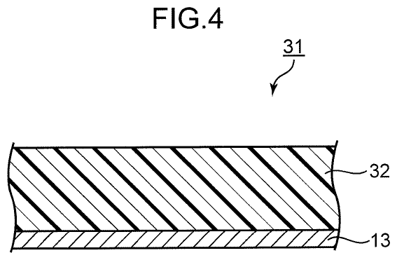

As illustrated in FIG. 4, a metal foil with resin 31 of the present embodiment has a configuration in which a resin layer 32 containing the resin composition described above or a semi-cured product of the resin composition; and a metal foil 13 are laminated. In other words, the metal foil with resin of the present embodiment may be a metal foil with resin including a resin layer containing the resin composition before curing (the resin composition in A stage) and a metal foil, or may be a metal foil with resin including a resin layer containing a semi-cured product of the resin composition (the resin composition in B stage) and a metal foil.

Examples of the method for fabricating such a metal foil with resin 31 include a method in which a resin composition in the form of a resin varnish as described above is applied to the surface of the metal foil 13 such as a copper foil and then dried. Examples of the application method include a bar coater, a comma coater, a die coater, a roll coater, and a gravure coater.

As the metal foil 13, metal foils used in metal-clad laminates, wiring boards and the like can be used without limitation, and examples thereof include copper foil and aluminum foil.

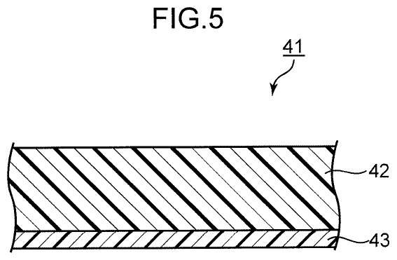

As illustrated in FIG. 5, a film with resin 41 of the present embodiment has a configuration in which a resin layer 42 containing the resin composition described above or a semi-cured product of the resin composition; and a film supporting base material 43 are laminated. In other words, the film with resin of the present embodiment may be a film with resin including the resin composition before curing (the resin composition in A stage); and a film supporting base material, or a film with resin including a semi-cured product of the resin composition (the resin composition in B stage); and a film supporting base material.

As the method for fabricating such a film with resin 41, for example, a resin composition in the form of a resin varnish as described above is applied to the surface of the film supporting base material 43, and then the solvent is volatilized from the varnish and diminished or removed, whereby a film with resin before curing (A stage) or in a semi-cured state (B stage) can be obtained.

Examples of the film supporting base material include electrical insulating films such as a polyimide film, a PET (polyethylene terephthalate) film, a polyethylene naphthalate film, a polyester film, a poly(parabanic acid) film, a polyether ether ketone film, a polyphenylene sulfide film, an aramid film, a polycarbonate film, and a polyarylate film.

In the film with resin and metal foil with resin of the present embodiment, the resin composition or semi-cured product thereof may be one obtained by drying or heating and drying the resin composition as in the prepreg described above.

The thickness and the like of the metal foil 13 and the film supporting base material 43 can be appropriately set depending on the desired purpose. For example, as the metal foil 13, a metal foil having a thickness of about 0.2 to 70 μm can be used. In a case where the thickness of metal foil is, for example, 10 μm or less, the metal foil may be a carrier-attached copper foil including a release layer and a carrier in order to improve handleability. The application of the resin varnish to the metal foil 13 and the film supporting base material 43 is performed by coating or the like, and this can be repeated multiple times if necessary. At this time, it is also possible to repeat coating using a plurality of resin varnishes having different compositions and concentrations, and adjust the composition (content ratio) and resin amount to the finally desired values.

Drying or heating and drying conditions in the fabrication method of the metal foil with resin 31 and film with resin 41 are not particularly limited, but a resin composition in the form of a resin varnish is applied to the metal foil 13 and film supporting base material 43, and then heating is performed under desired heating conditions, for example, at 50° C. to 180° C. for about 0.1 to 10 minutes to volatilize the solvent from the varnish and diminish or remove the solvent, whereby the metal foil with resin 31 and film with resin 41 before curing (A stage) or in a semi-cured state (B stage) are obtained.

The metal foil with resin 31 and film with resin 41 may include a cover film and the like, if necessary. By including a cover film, it is possible to prevent foreign matter from entering. The cover film is not particularly limited as long as it can be peeled off without damaging the form of the resin composition, and for example, a polyolefin film, a polyester film, a TPX film, films formed by providing a release agent layer on these films, and paper obtained by laminating these films on a paper substrate can be used.

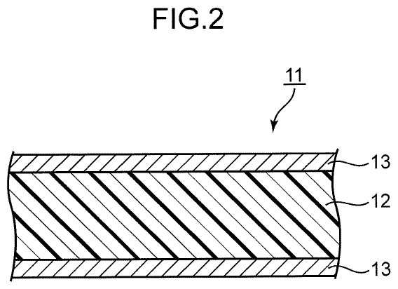

As illustrated in FIG. 2, a metal-clad laminate 11 of the present embodiment includes an insulating layer 12 containing a cured product of the resin composition described above or a cured product of the prepreg described above; and a metal foil 13. As the metal foil 13 used in the metal-clad laminate 11, a metal foil similar to the metal foil 13 described above can be used.

The metal-clad laminate 11 of the present embodiment can also be fabricated using the metal foil with resin 31 or film with resin 41 described above.

As the method for fabricating a metal-clad laminate using the prepreg 1, metal foil with resin 31, or film with resin 41 obtained in the manner described above, one or a plurality of prepregs 1, metal foils with resin 31, or films with resin 41 are superimposed on one another, and the metal foils 13 such as copper foil are further superimposed on both upper and lower sides or on one side, and this is laminated and integrated by heating and pressing, whereby a double-sided metal-clad or single-sided metal-clad laminate can be fabricated. The heating and pressing conditions can be appropriately set depending on the thickness of the laminate to be fabricated, the kind of the resin composition, and the like, but for example, the temperature may be set to 170° C. to 230° C., the pressure may be set to 1.5 to 5.0 MPa, and the time may be set to 60 to 150 minutes.

The metal-clad laminate 11 may be fabricated by forming a film-like resin composition on the metal foil 13 without using the prepreg 1 or the like and performing heating and pressing.

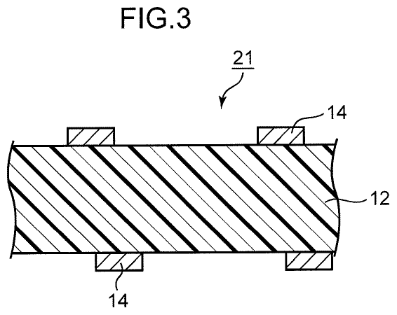

As illustrated in FIG. 3, a wiring board 21 of the present embodiment includes wiring 14 and an insulating layer 12 containing a cured product of the resin composition described above or a cured product of the prepreg described above.

The resin composition of the present embodiment is suitably used as a material for an insulating layer of a wiring board. As the method for fabricating the wiring board 21, for example, the metal foil 13 on the surface of the metal-clad laminate 11 obtained above is etched to form a circuit (wiring), whereby the wiring board 21 having a conductor pattern (wiring 14) provided as a circuit on the surface of a laminate can be obtained. Examples of the circuit forming method include circuit formation by a semi additive process (SAP) or a modified semi additive process (MSAP) in addition to the method described above.

The prepreg, film with resin, and metal foil with resin obtained using the resin composition of the present embodiment are extremely useful in industrial applications since the cured products thereof exhibit excellent low dielectric properties and low thermal expansion properties. The metal-clad laminate and wiring board obtained by curing these also exhibit low dielectric properties and low thermal expansion properties.

This specification discloses techniques in various aspects as described above, and the main techniques among them are summarized below.

A resin composition according to a first aspect of the present invention contains a hydrocarbon-based compound (A) represented by Formula (1), a polyphenylene ether compound (B) having a reactive carbon-carbon unsaturated double bond, and at least one of a polyfunctional vinyl aromatic copolymer (C) or an acenaphthylene compound (D).

A resin composition according to a second aspect of the present invention is the resin composition according to the first aspect, in which the hydrocarbon-based compound (A) includes a hydrocarbon-based compound (A1) represented by Formula (2).

A resin composition according to a third aspect of the present invention is the resin composition according to the first or second aspect, in which a content of the hydrocarbon compound (A) is 5 to 50 parts by mass with respect to 100 parts by mass of a total mass of the hydrocarbon-based compound (A), the polyphenylene ether compound (B), the polyfunctional vinyl aromatic copolymer (C), and the acenaphthylene compound (D).

A resin composition according to a fourth aspect of the present invention is the resin composition according to any one of the first to third aspects, in which a content of the polyphenylene ether compound (B) is 5 to 50 parts by mass with respect to 100 parts by mass of a total mass of the hydrocarbon-based compound (A), the polyphenylene ether compound (B), the polyfunctional vinyl aromatic copolymer (C), and the acenaphthylene compound (D).

A resin composition according to a fifth aspect of the present invention is the resin composition according to any one of the first to fourth aspects, in which a content of the polyfunctional vinyl aromatic copolymer (C) is 0 to 50 parts by mass with respect to 100 parts by mass of a total mass of the hydrocarbon-based compound (A), the polyphenylene ether compound (B), the polyfunctional vinyl aromatic copolymer (C), and the acenaphthylene compound (D).

A resin composition according to a sixth aspect of the present invention is the resin composition according to any one of the first to fifth aspects, in which a content of the acenaphthylene compound is 0 to 30 parts by mass with respect to 100 parts by mass of a total mass of the hydrocarbon-based compound (A), the polyphenylene ether compound (B), the polyfunctional vinyl aromatic copolymer (C), and the acenaphthylene compound (D).

A resin composition according to a seventh aspect of the present invention is the resin composition according to any one of the first to sixth aspects, containing a phosphorus-based flame retardant.

A resin composition according to an eighth aspect of the present invention is the resin composition according to any one of the first to seventh aspects, containing an inorganic filler.

A prepreg according to a ninth aspect of the present invention includes the resin composition according to any one of the first to eighth aspects or a semi-cured product of the resin composition; and a fibrous base material.

A film with resin according to a tenth aspect of the present invention includes a resin layer containing the resin composition according to any one of the first to eighth aspects or a semi-cured product of the resin composition; and a support film.

A metal foil with resin according to an eleventh aspect of the present invention includes a resin layer containing the resin composition according to any one of the first to eighth aspects or a semi-cured product of the resin composition; and a metal foil.

A metal-clad laminate according to a twelfth aspect of the present invention includes an insulating layer containing a cured product of the resin composition according to any one of the first to eighth aspects or a cured product of the prepreg according to the ninth aspect; and a metal foil.

A wiring board according to a thirteenth aspect of the present invention includes an insulating layer containing a cured product of the resin composition according to any one of the first to eighth aspects or a cured product of the prepreg according to the ninth aspect; and a wiring.

Hereinafter, the present invention will be described more specifically with reference to Examples, but the scope of the present invention is not limited thereto.

### EXAMPLES

First, the components to be used in the preparation of resin compositions in the present Examples will be described.

### (Hydrocarbon-Based Compound (A))

### Production of Hydrocarbon-Based Compound 1

First, the weight average molecular weight (Mw) and number average molecular weight (Mn) used in the production of hydrocarbon-based compound 1 below are values determined by the following analysis method.

### (Analysis Method)

The molecular weights were calculated in terms of polystyrene using a polystyrene standard solution.
GPC: DGU-20A3R, LC-20AD, SIL-20AHT, RID-20A, SPD-20A, CTO-2, CBM-20A
(all manufactured by Shimadzu Corporation)
Column: Shodex KF-603, KF-602×2, KF-601×2)
Coupled eluent: Tetrahydrofuran
Flow velocity: 0.5 ml/min.
Column temperature: 40° C.
Detection: R1 (differential refraction detector)

### Synthesis Example 1

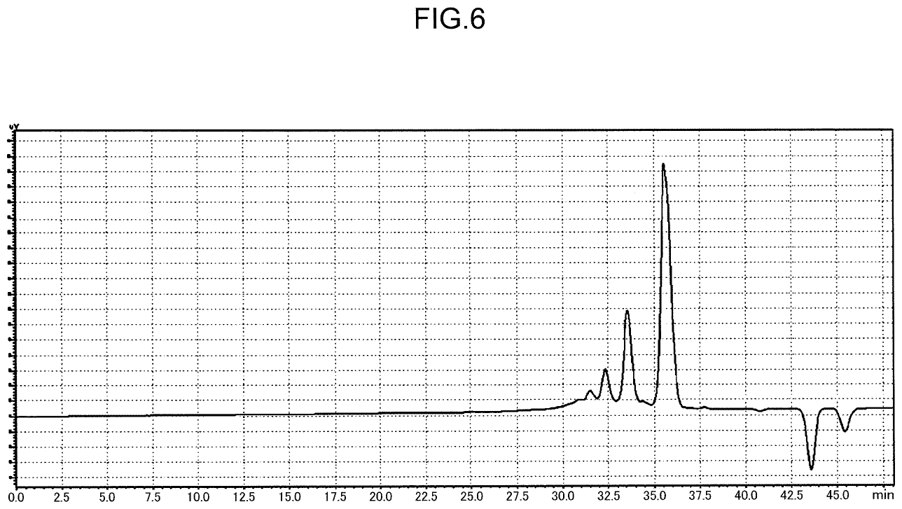

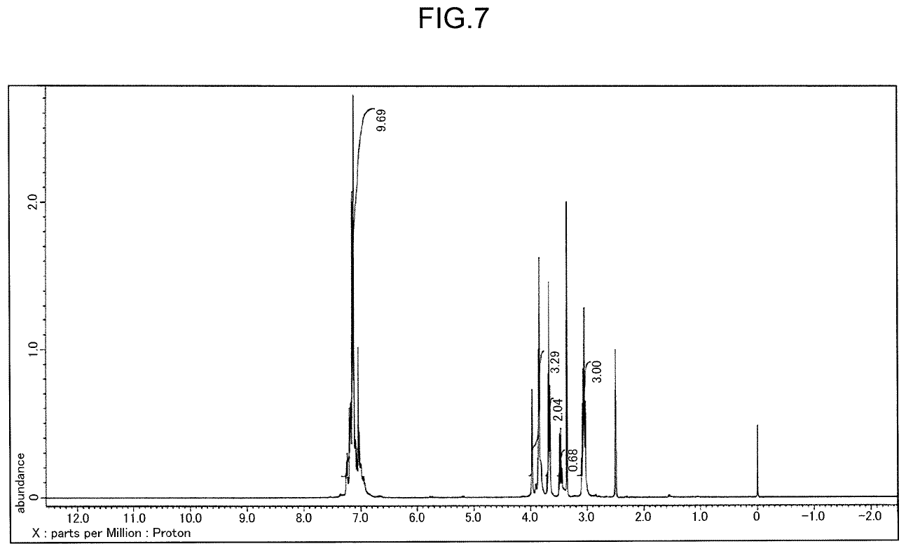

Into a flask equipped with a thermometer, a condenser, and a stirrer, 296 parts of 2-bromoethylbenzene (manufactured by Tokyo Chemical Industry Co., Ltd.), 70 parts of α,α′-dichloro-p-xylene (manufactured by Tokyo Chemical Industry Co., Ltd.), and 18.4 parts of methanesulfonic acid (manufactured by Tokyo Chemical Industry Co., Ltd.) were introduced, and the reaction was conducted at 130° C. for 8 hours. After being left to cool, the reaction mixture was neutralized with an aqueous sodium hydroxide solution, and subjected to extraction with 1200 parts of toluene, and the organic layer was washed with 100 parts of water five times. The solvent and excess 2-bromoethylbenzene were distilled off under heating and reduced pressure to obtain 160 parts of an olefin compound precursor (BEB-1) having a 2-bromoethylbenzene structure as a liquid resin (Mn: 538, Mw: 649). A GPC chart of the obtained compound is illustrated in FIG. 6. The repeating unit n calculated from the area % in the GPC chart was 1.7. A ¹H-NMR chart (DMSO-d6) of the obtained compound is illustrated in FIG. 7. Signals attributed to a bromoethyl group were observed at 2.95 to 3.15 ppm and 3.60 to 3.75 ppm on the ¹H-NMR chart.

### Synthesis Example 2

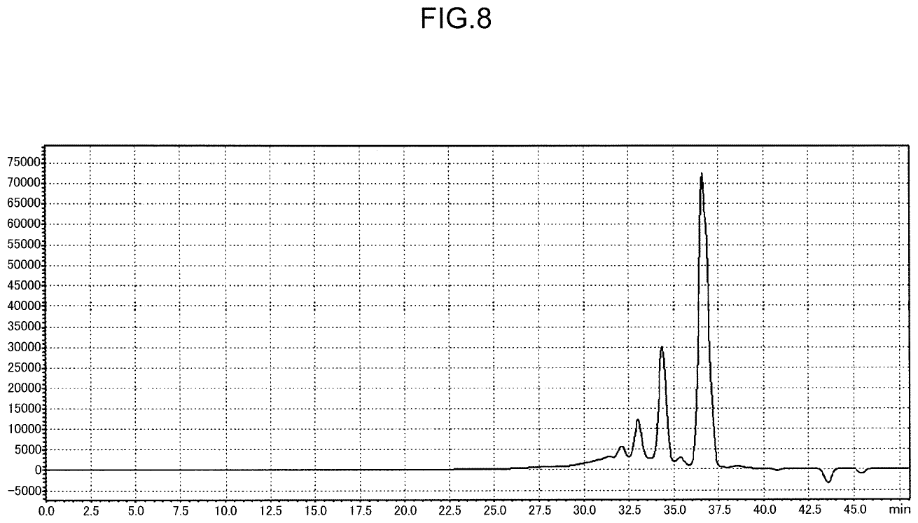

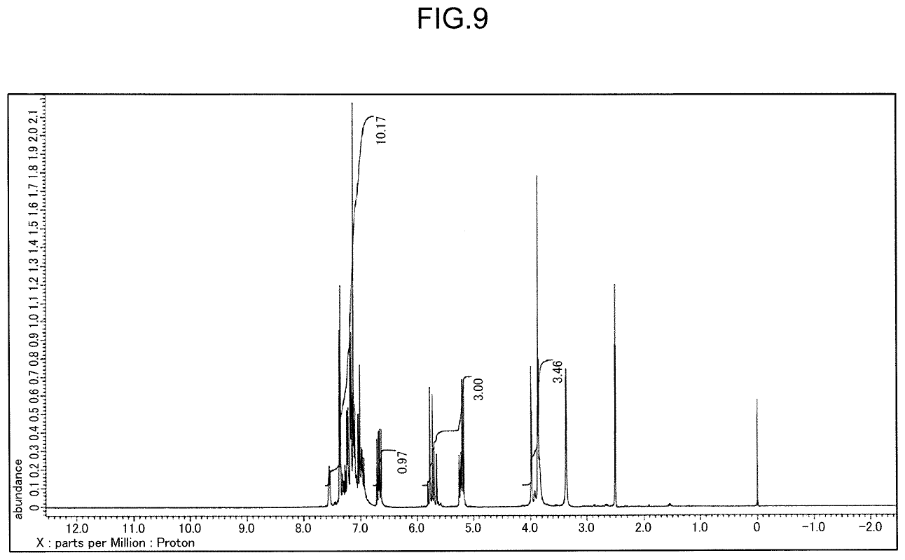

Next, 22 parts of BEB-1 obtained in Synthesis Example 1, 50 parts of toluene, 150 parts of dimethyl sulfoxide, 15 parts of water and 5.4 parts of sodium hydroxide were introduced into a flask equipped with a thermometer, a condenser, and a stirrer, and the reaction was conducted at 40° C. for 5 hours. After standing to cool, 100 parts of toluene was added, the organic layer was washed with 100 parts of water five times, and the solvent was distilled off under heating and reduced pressure to obtain 13 parts of a liquid olefin compound having a styrene structure as a functional group (Mn: 432, Mw: 575). A GPC chart of the obtained compound is illustrated in FIG. 8. The repeating unit n calculated from the area % in the GPC chart was 1.7. A ¹H-NMR data (DMSO-d6) of the obtained compound is illustrated in FIG. 9. Signals attributed to a vinyl group were observed at 5.10 to 5.30 ppm, 5.50 to 5.85 ppm, and 6.60 to 6.80 ppm on the ¹H-NMR chart.

The liquid olefin compound was referred to as hydrocarbon-based compound 1.

### (Modified Polyphenylene Ether Compound (B))

Modified PPE: Modified polyphenylene ether obtained by reacting polyphenylene ether with chloromethylstyrene. Specifically, this is modified polyphenylene ether obtained by conducting a reaction as follows.

First, 200 g of polyphenylene ether (SA90 manufactured by SABIC Innovative Plastics Co., Ltd., number of terminal hydroxyl groups: 2, weight average molecular weight Mw 1700), 30 g of a mixture containing p-chloromethylstyrene and m-chloromethylstyrene at a mass ratio of 50:50 (chloromethylstyrene: CMS manufactured by Tokyo Chemical Industry Co., Ltd.), 1.227 g of tetra-n-butylammonium bromide as a phase transfer catalyst, and 400 g of toluene were introduced into a 1-liter three-necked flask equipped with a temperature controller, a stirrer, cooling equipment, and a dropping funnel and stirred. Then, the mixture was stirred until polyphenylene ether, chloromethylstyrene, and tetra-n-butylammonium bromide were dissolved in toluene. At that time, the mixture was gradually heated until the liquid temperature finally reached 75° C. Then, an aqueous sodium hydroxide solution (20 g of sodium hydroxide/20 g of water) as an alkali metal hydroxide was added dropwise to the solution over 20 minutes. Thereafter, the mixture was further stirred at 75° C. for 4 hours. Next, the resultant in the flask was neutralized with hydrochloric acid at 10 mass % and then a large amount of methanol was added into the flask. By doing so, a precipitate was generated in the liquid in the flask. In other words, the product contained in the reaction solution in the flask was reprecipitated. Then, this precipitate was taken by filtration and washed three times with a liquid mixture of methanol and water at a mass ratio of 80:20, and then dried at 80° C. under reduced pressure for 3 hours.

The obtained solid was analyzed by ¹H-NMR (400 MlIz, CDCl₃, TMS). As a result of NMR measurement, a peak attributed to ethenylbenzyl was confirmed at 5 to 7 ppm. This confirmed that the obtained solid was polyphenylene ether in which the terminals of the molecule were ethenylbenzylated.

The number of terminal functional groups in the modified polyphenylene ether was measured as follows. First, the modified polyphenylene ether was accurately weighed. The weight at that time is defined as X (mg). Thereafter, this modified polyphenylene ether weighed was dissolved in 25 mL of methylene chloride, 100 μL of an ethanol solution of tetraethylammonium hydroxide (TEAH) at 10 mass % (TEAH:ethanol (volume ratio)=15:85) was added to the solution, and then the absorbance (Abs) of this mixture at 318 nm was measured using a UV spectrophotometer (UV-1600 manufactured by Shimadzu Corporation). Then, the number of terminal hydroxyl groups in the modified polyphenylene ether was calculated from the measurement results using the following equation.

$$Residual OH amount ( μ mo l / g ) = [ ( 25 \times Ab s ) / ( ε \times OPL \times X ) ] \times 1 {0}^{6}$$

Here, ε denotes the extinction coefficient and is 4700 L/mol·cm. OPL denotes the cell optical path length and is 1 cm.

Since the calculated residual OH amount (the number of terminal hydroxyl groups) in the modified polyphenylene ether is almost zero, it was found that the hydroxyl groups in the polyphenylene ether before being modified are almost modified. From this fact, it was found that the number of terminal hydroxyl groups decreased from the number of terminal hydroxyl groups in polyphenylene ether before being modified was the number of terminal hydroxyl groups in polyphenylene ether before being modified. In other words, it was found that the number of terminal hydroxyl groups in polyphenylene ether before being modified was the number of terminal functional groups in the modified polyphenylene ether. In other words, the number of terminal functional groups was 2.

In addition, an intrinsic viscosity (IV) of the modified polyphenylene ether was measured in methylene chloride at 25° C. Specifically, the intrinsic viscosity (IV) of the modified polyphenylene ether was measured in a methylene chloride solution (liquid temperature: 25° C.) of the modified polyphenylene ether at 0.18 g/45 ml using a viscometer (AVS500 Visco System manufactured by SCHOTT Instruments GmbH). As a result, the intrinsic viscosity (IV) of the modified polyphenylene ether was 0.086 dl/g.

The molecular weight distribution of the modified polyphenylene ether was measured by GPC. Moreover, the weight average molecular weight (Mw) was calculated from the obtained molecular weight distribution. As a result, Mw was 2300.

### (Polyfunctional Vinyl Aromatic Polymer (C))

A polyfunctional vinyl aromatic polymer was obtained based on the following method: Into a 5.0 L reactor, 3.0 mole (390.6 g) of divinylbenzene, 1.8 mole (229.4 g) of ethylvinylbenzene, 10.2 mole (1066.3 g) of styrene and 15.0 mole (1532.0 g) of n-propyl acetate were charged, 600 mmole of boron trifluoride diethyl ether complex was added at 70° C., and the reaction was conducted for 4 hours. After the polymerization solution was terminated with an aqueous sodium bicarbonate solution, the oil layer was washed three times with pure water and volatilized under reduced pressure at 60° C. to recover the solid (polymer). The obtained solid was weighed and found to be 896.7 g.

The structure of the obtained solid (polymer) was measured by 13C-NMR and ¹H-NMR analysis using a nuclear magnetic resonance spectrometer, Model JNM-LA600 manufactured by JEOL Ltd. Chloroform-dl was used as the solvent and the resonance line of tetramethylsilane was used as the internal standard. In addition to the 13C-NMR and ¹H-NMR measurement results, the amount of a specific structural unit introduced was calculated from the data on the total amount of the respective structural units introduced into the copolymer acquired by GC analysis, and the amount of the pendant vinyl group units contained in the polyfunctional vinyl aromatic copolymer was calculated from the amount of the specific structural unit introduced at the terminal and the number average molecular weight acquired by the GPC measurement.

The obtained solid was subjected to ¹³C-NMR and ¹H-NMR analysis as described above to observe resonance lines derived from each monomer unit. Based on the results of NMR measurement and the results of GC analysis, it was found that this solid was the polyfunctional vinyl aromatic copolymer. The structural units of this polyfunctional vinyl aromatic copolymer were calculated as follows based on the results of NMR measurement and the results of GC analysis. The structural unit derived from divinylbenzene was 30.4 mol % (33.1 mass %), the structural unit derived from styrene was 57.4 mol % (52.7 mass %), the structural unit derived from ethylvinylbenzene was 12.2 mol % (14.2 mass %), and the structural unit having a residual vinyl group, which was derived from divinylbenzene, was 23.9 mol % (25.9 mass %).

The molecular weight and molecular weight distribution of the obtained solid (polyfunctional vinyl aromatic copolymer) were measured using tetrahydrofuran as a solvent and a calibration curve created using monodisperse polystyrene at a flow rate of 1.0 ml/min and a column temperature of 38° C. using GPC (HLC-8120GPC manufactured by Tosoh Corporation). As a result, the obtained solid had a number average molecular weight Mn of 2980, a weight average molecular weight Mw of 41300, and Mw/Mn of 13.9.

### (Acenaphthylene Compound (D))

Acenaphthylene (manufactured by JFE Chemical Corporation)

### (Inorganic Filler)

DENKA FUSED SILICA LOW DIELECTRIC LOSS TANGENT TYPE (manufactured by Denka Company Limited, spherical silica)

### Examples 1 to 3 and Comparative Examples 1 to 3

### Preparation Method

### (Resin Varnish)

First, the respective components were added to and mixed in toluene at the blending proportions (parts by mass) presented in Table 1 so that the solid concentration of the resin component was 50 mass %. The obtained mixture was stirred for 60 minutes to obtain a resin varnish.

### (Fabrication of Evaluation Substrate)

A prepreg and an evaluation substrate (metal-clad laminate) were obtained as follows.

First, the obtained varnish was impregnated into a fibrous base material (glass cloth: #2116 type, NE Glass manufactured by Nitto Boseki Co., Ltd.) and then heated and dried at 120° C. for 3 minutes, thereby fabricating a prepreg having a resin thickness of 100 μm. At that time, the content (resin content) of the component constituting the resin composition by the curing reaction with respect to the prepreg was adjusted to be 45 mass %.

Next, an evaluation substrate (metal-clad laminate) was obtained as follows.

Two sheets of each of the obtained prepregs were stacked, and copper foil (“CF-T4X-SV” manufactured by FUKUDA METAL FOIL & POWDER CO., LTD., copper foil thickness: 18 μm) was disposed on both sides of the stacked body. This as a body to be pressed was heated to a temperature of 220° C. at a rate of temperature rise of 3° C./min and heated and pressed under the conditions of 220° C., 120 minutes, and a pressure of 3 MPa, thereby obtaining an evaluation substrate (metal-clad laminate) having copper foil bonded to both surfaces and having a resin layer thickness of about 200 μm.

The evaluation substrates (metal-clad laminates) fabricated as described above were used to conduct evaluation tests by the following methods.

### <Evaluation Test 1>

### (Glass Transition Temperature (Tg))

Using an unclad plate obtained by removing the copper foil from the evaluation substrate obtained above by etching, Tg was measured using a viscoelastic spectrometer “DMS6100” manufactured by Seiko Instruments Inc. At this time, dynamic viscoelasticity measurement (DMA) was performed in a tensile module at a frequency of 10 Hz, and the temperature at which tan 8 was maximized when the temperature was raised from room temperature to 350° C. at a rate of temperature rise of 5° C./min was taken as Tg. In the present test, it is determined as acceptable when the Tg is 240° C. or more.

### (Dielectric Properties: Dielectric Loss Tangent (Df))

The relative dielectric constant and dielectric loss tangent at 10 GHz were measured by the cavity perturbation method using an unclad substrate obtained by removing the copper foil from the evaluation substrate (metal-clad laminate) by etching as a test piece. Specifically, the dielectric loss tangent of the evaluation substrate at 10 GHz was measured using a network analyzer (N5230A manufactured by Keysight Technologies). In the present test, it is determined as acceptable when the Df is 0.0023 or less.

### (Coefficient of Thermal Expansion (CTE))

Using an unclad substrate obtained by removing the copper foil from the evaluation substrate (metal-clad laminate) by etching as a test piece, the coefficient of thermal expansion in the surface direction of the base material (tensile direction, Y direction) at a temperature less than the glass transition temperature of the resin cured product was measured by the TMA (Thermo-mechanical analysis) method. Specifically, a TMA system (“TMA6000)” manufactured by SII Nano Technology Inc.) was used for the measurement, and the measurement was performed in a tensile mode. In order to eliminate the influence of thermal strain on the test piece, the heating-cooling cycle was repeated two times, and the average coefficient of thermal expansion from 50° C. to 100° C. in the second temperature change chart was measured. A smaller value means a more preferable result, and in the present test, it is determined as acceptable when the CTE is 10 ppm/° C. or less. The unit is ppm/° C.

### [Measurement Conditions]

1st cycle: Range of temperature rise 30° C.→320° C.
Rate of temperature rise: 20° C./min, Load: 10 g
2nd cycle: Range of temperature rise 30° C.→320° C.
Rate of temperature rise: 10° C./min, Load: 10 g

### (Thermogravimetric Analysis (TGA))

An unclad plate obtained by removing the copper foil from the evaluation substrate (metal-clad laminate) by etching was used as a test piece, and thermogravimetric analysis was performed. Specifically, thermogravimetric analysis was performed using a TG-DTA8122 (equipped with infrared furnace IRF-12) manufactured by Rigaku Holdings Corporation under measurement conditions of 90° C./min in an air atmosphere, and the temperature at which the weight loss reached 5% was evaluated. In the present test, it was evaluated as acceptable when the TGA was 450° C. or more.

The results are presented in Table 1.

TABLE 1

| | | | | | Comparative | Comparative | Comparative |
|---|---|---|---|---|---|---|---|
| | | Example 1 | Example 2 | Example 3 | Example 1 | Example 2 | Example 3 |
| Composition | Hydrocarbon-based compound (A) | 35 | 47 | 23.5 | — | 20 | — |
| (parts by | Modified polyphenylene ether (B) | 30 | 30 | 30 | 70 | — | 30 |
| mass) | Polyfunctional vinyl aromatic polymer (C) | 35 | — | 23.5 | 30 | 50 | 47 |
| | Acenaphthylene (D) | — | 23 | 23 | — | 30 | 23 |
| | Inorganic filler | 60 | 60 | 60 | 60 | 60 | 60 |
| Evaluation | Tg | 241 | 267 | 255 | 231 | 216 | 242 |
| result | Df @10 GHz | 0.00205 | 0.0022 | 0.0021 | 0.00242 | 0.00193 | 0.00212 |
| | Coefficient of thermal | 9.2 | 7.8 | 9.3 | 12.1 | 10.5 | 10.1 |
| | expansion (ppm/° C.) | | | | | | |
| | TGA | 467 | 505 | 481 | 451 | 436 | 426 |

### Discussion

As is clear from the results presented in Table 1, it was found that a cured product exhibiting low dielectric properties and a low coefficient of thermal expansion is obtained from the resin composition of the present invention. Furthermore, it was found that the cured products of the resin compositions of Examples have high Tg and TGA.

In contrast, in Comparative Examples in which a resin composition not containing the hydrocarbon-based compound (A) or a resin composition not containing the modified polyphenylene ether compound (B) is used, sufficient effects cannot attained in terms of low dielectric properties or low thermal expansion properties or both of these.

### <Evaluation Test 2>

The copper foil was peeled off from the evaluation substrates (metal-clad laminates) of Examples 1 to 3, and the peel strength at that time was measured in conformity with JIS C 6481. Specifically, the evaluation substrate was cut to have a width and a length of 10 mm, the copper foil was peeled off at a speed of 50 mm/min using a tensile tester, and the peel strength (N/mm) at that time was measured. In the present test, a peel strength of 0.4 N/mm or more is determined as excellent.

The results are presented in Table 2.

TABLE 2

| | | Example 1 | Example 2 | Example 3 |
|---|---|---|---|---|
| Composition | Hydrocarbon-based compound (A) | 35 | 47 | 23.5 |
| (parts by mass) | Modified polyphenylene ether (B) | 30 | 30 | 30 |
| | Polyfunctional vinyl aromatic | 35 | — | 23.5 |
| | polymer (C) | | | |
| | Acenaphthylene (D) | — | 23 | 23 |
| | Inorganic filler | 60 | 60 | 60 |
| Evaluation result | Copper foil peel strength (N/mm) | 0.389 | 0.409 | 0.448 |

### Discussion

From the results in Table 2, it was found that a cured product exhibiting higher adhesive properties is obtained by containing the acenaphthylene compound (D).

This application is based on Japanese patent application No. 2022-180984 filed on Nov. 11, 2022, the contents of which are included in the present application.

In order to express the present invention, the present invention has been described above appropriately and sufficiently through the embodiments with reference to specific examples, drawings and the like. However, it should be recognized by those skilled in the art that changes and/or improvements of the above-described embodiments can be readily made. Accordingly, changes or improvements made by those skilled in the art shall be construed as being included in the scope of the claims unless otherwise the changes or improvements are at the level which departs from the scope of the appended claims.

### INDUSTRIAL APPLICABILITY

The present invention has wide industrial applicability in technical fields such as electronic materials, electronic devices, and optical devices.

1. A resin composition comprising:
a hydrocarbon-based compound (A) represented by the following Formula (1): 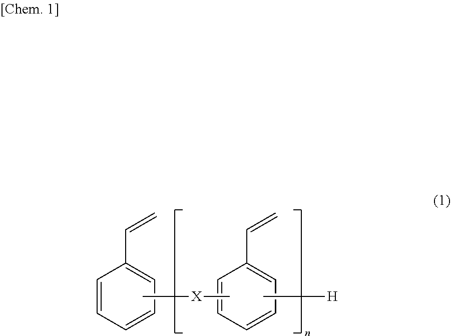
wherein X represents a hydrocarbon group having 6 or more carbon atoms, which includes at least one selected from an aromatic cyclic group or an aliphatic cyclic group, and n represents an integer from 1 to 10;
a polyphenylene ether compound (B) having a reactive carbon-carbon unsaturated double bond; and
at least one of a polyfunctional vinyl aromatic copolymer (C) or an acenaphthylene compound (D).

2. The resin composition according to claim 1, wherein
the hydrocarbon-based compound (A) includes a hydrocarbon-based compound (A1) represented by the following Formula (2): 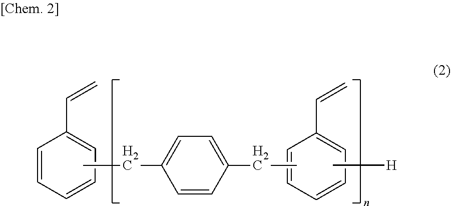
wherein n represents an integer from 1 to 10.

3. The resin composition according to claim 1, wherein a content of the hydrocarbon-based compound (A) is 5 to 50 parts by mass with respect to 100 parts by mass of a total mass of the hydrocarbon-based compound (A), the polyphenylene ether compound (B), the polyfunctional vinyl aromatic copolymer (C), and the acenaphthylene compound (D).

4. The resin composition according to claim 1, wherein a content of the polyphenylene ether compound (B) is 5 to 50 parts by mass with respect to 100 parts by mass of a total mass of the hydrocarbon-based compound (A), the polyphenylene ether compound (B), the polyfunctional vinyl aromatic copolymer (C), and the acenaphthylene compound (D).

5. The resin composition according to claim 1, wherein a content of the polyfunctional vinyl aromatic copolymer (C) is 0 to 50 parts by mass with respect to 100 parts by mass of a total mass of the hydrocarbon-based compound (A), the polyphenylene ether compound (B), the polyfunctional vinyl aromatic copolymer (C), and the acenaphthylene compound (D).

6. The resin composition according to claim 1, wherein a content of the acenaphthylene compound (D) is 0 to 30 parts by mass with respect to 100 parts by mass of a total mass of the hydrocarbon-based compound (A), the polyphenylene ether compound (B), the polyfunctional vinyl aromatic copolymer (C), and the acenaphthylene compound (D).

7. The resin composition according to claim 1, comprising a phosphorus-based flame retardant.

8. The resin composition according to claim 1, comprising an inorganic filler.

9. A prepreg comprising:
the resin composition according to claim 1 or a semi-cured product of the resin composition; and
a fibrous base material.

10. A film with resin comprising:
a resin layer containing the resin composition according to claim 1 or a semi-cured product of the resin composition; and
a support film.

11. A metal foil with resin comprising:
a resin layer containing the resin composition according to claim 1 or a semi-cured product of the resin composition; and
a metal foil.

12. A metal-clad laminate comprising:
an insulating layer containing a cured product of the resin composition according to claim 1; and
a metal foil.

13. A wiring board comprising:
an insulating layer containing a cured product of the resin composition according to claim 1; and
a wiring.

14. A metal-clad laminate comprising:
an insulating layer containing a cured product of the prepreg according to claim 9; and
a metal foil.

15. A wiring board comprising:
an insulating layer containing a cured product of the prepreg according to claim 9; and
a wiring.
